(19) United States
(12) Patent Application Publication
(10) Pub. No.: US 2019/0383332 A1
(43) Pub. Date: Dec. 19, 2019

(54) RESIN BOOT

(71) Applicant: FUKOKU CO., LTD., Saitama (JP)

(72) Inventor: Yuzo ONO, Saitama (JP)

(73) Assignee: FUKOKU CO., LTD., Saitama (JP)

(21) Appl. No.: 16/464,032

(22) PCT Filed: Dec. 6, 2017
(86) PCT No.: PCT/JP2017/043760

§ 371 Date: May 24, 2019

(30) Foreign Application Priority Data
Dec. 15, 2016 (JP) 2016-243573

(51) Int. Cl. F16D 3/84; F16J 3/04

(52) U.S. Cl. CPC F16D 3/845; F16J 3/041

(57) ABSTRACT

An object is to provide a resin boot that can stably exert suppression effect for rubbing noise over a long period without being influenced by rotation direction. For achieving the object, a resin boot in the present invention includes a cylindrical boot bellows portion formed such that a convex portion and a concave portion alternately continue, and the boot bellows portion includes a plurality of crossed linear grooves, on a surface of a boot slope that connects a top of the convex portion and a bottom of the concave portion.

### TECHNICAL FIELD

The present invention relates to a resin boot for a vehicle that covers a joining part allowing a plurality of machine elements to change relatively. Particularly, the present invention relates to a boot for a constant-velocity universal joint that covers a constant-velocity universal joint used in a driving shaft or propeller shaft of the vehicle.

### BACKGROUND ART

Generally, in a driving shaft or propeller shaft of a vehicle, a constant-velocity universal joint for transmitting rotation from the driving shaft or the like to a driven shaft or the like at a constant velocity is used. For the purpose of the encapsulation of grease as lubricant and the prevention of the intrusion of dust or water from the exterior, a flexible boot for the constant-velocity universal joint is attached to the constant-velocity universal joint.

Further, the boot for the constant-velocity universal joint is composed of a material having a good weather resistance, for following the high-speed rotation and slide at various operating angles during traveling. As the material of the boot, generally, chloroprene rubber is employed, but cannot be recycled because of a vulcanized rubber. Hence, in recent years, a thermoplastic polyester elastomer that can be recycled and that has a good durability is often employed. The thermoplastic polyester elastomer is also superior to the chloroprene rubber in rigidity, tear strength and low-temperature performance. However, the thermoplastic polyester elastomer is inferior to the chloroprene rubber in flexibility, and therefore, for improving the flexibility, it is necessary to form a greater number of convex portions and concave portions that construct a bellows portion.

In the boot for the constant-velocity universal joint that is thus constructed in a greater number of convex portions and concave portions for improving the flexibility, the interference between surfaces of the shrink side of the bellows portion becomes greater as the operating angle of the constant-velocity universal joint becomes larger. Particularly, when the bellows portion surface is wet with water, surfaces on the shrink side of the bellows portion are strongly rubbed with each other, and thereby, a vibration phenomenon called stick-slip occurs due to the difference in friction coefficient between a surface part that is wet with water and a surface part that is not wet with water. The vibration phenomenon often causes a rubbing noise (abnormal sound). Until recently, the friction sound is hardly a problem. However, since the vehicle has become quieter with the popularization of hybrid vehicles, the reduction in the rubbing noise is required by the market.

For example, it is disclosed that a boot for a constant-velocity joint described in Patent Literature 1 forms grooves for discharging fluid from a bottom side to a convex portion side, on an outer circumference surface of a bellows portion, and discharges the fluid out of the bellows portion by the centrifugal force generated by the rotation of the boot.

Further, it is disclosed that a boot for a constant-velocity universal joint described in Patent Literature 2 provides linear protrusions crossing each other, between facing slopes in a bellows portion, and thereby, reduces the interference between the slopes, to suppress the generation of the rubbing noise due to the stick-slip.

### CITATION LIST

### Patent Literature

[Patent Literature 1] JP2015-113879A
[Patent Literature 2] JP2015-132334A

### SUMMARY OF INVENTION

### Technical Problem

The grooves formed on the boot for the constant-velocity joint in Patent Literature 1 is radially formed from the center line of the boot radially-directional outward, and therefore, the actual direction in which water droplets flow outward by the centrifugal force does not coincide with the direction of the formation of the groove, so that an efficient discharge of water droplets is obstructed. Furthermore, Patent Literature 1 also discloses that the grooves are radially formed at predetermined angles. However, the centrifugal force to be generated in the boot by the rotation of the constant-velocity joint differs for the boot attached to the left side of the constant velocity joint and the boot attached to the right side of the constant velocity joint, and therefore, it is necessary to manufacture a boot in which the grooves are formed so as to be inclined at predetermined angles respectively corresponding to the right and left rotation directions. As a result, there is a problem that the productivity is poor and the installation workability is complicated. In addition, the rotation direction of the boot differs between the forward movement and backward movement of the vehicle, and therefore, if the grooves having a predetermined angle are formed in the boot so as to prioritize drainage efficiency during forward rotation, drainage efficiency during negative rotation will be low. As a result, it becomes impossible to realize the reduction of the rubbing noise.

Further, although the boot for the constant-velocity universal joint in Patent Literature 2 suppresses the rubbing noise by the formation of the protrusions, a large frictional force is generated on the protrusions when the surfaces of the slopes of the bellows portion are strongly pressed onto each other, and therefore, the boot is easily worn away. Therefore, it is difficult to maintain the suppression effect of rubbing noise for a long time, and the boot is not suitable for actual use.

Under such a situation, the market has demanded the development of a resin boot that can stably exert the effect of suppressing the rubbing noise for a long period regardless of the rotational direction.

### Solution to Problem

Hence, as a result of diligent study, the inventors provide a resin boot that can be used in common without depending on the rotation direction and that can keep the suppression effect for the rubbing noise over a long period.

That is, a resin boot according to the present invention includes a cylindrical bellows portion formed such that convex portions and concave portions alternately continue in an axial direction, the bellows portion includes a plurality of crossed linear grooves, on a surface of a slope that connects a top of the convex portion and a bottom of the concave portion.

In the resin boot according to the present invention, it is preferable that the linear grooves extend to the top of the convex portion.

Further, in the resin boot according to the present invention, it is preferable that the linear grooves are included on at least one of slopes that face each other across the bottom.

Furthermore, in the resin boot according to the present invention, it is preferable that the linear grooves are formed at an angle of 40° to 80° or −40° to −80° with respect to a radial center line of the resin boot.

Further, in the resin boot according to the present invention, it is preferable that a depth of the linear grooves are 5% to 30% of a thickness of the slope.

Furthermore, in the resin boot according to the present invention, it is preferable that a width of the linear grooves are 100 μm to 800 μm.

Further, in the resin boot according to the present invention, it is preferable that the number of island regions surrounded by the linear grooves be 16 to 90 island regions/cm².

Furthermore, in the resin boot according to the present invention, it is preferable that a cross-section of the linear grooves have a trapezoidal shape.

A boot for a constant-velocity universal joint according to the present invention is the above-described resin boot and includes: a large-diameter-side end portion into which an outer housing of the constant-velocity universal joint is inserted; and a small-diameter-side end portion into which a shaft member is inserted, the shaft member being joined to the constant-velocity universal joint, in which the linear grooves are included on at least one of slopes that face each other across the bottom, at least parts of the slopes coming into contact with each other when an operating angle is 30° or more, the operating angle being a cross angle between an axis line of the outer housing and an axis line of the shaft member.

### Advantageous Effects of Invention

According to the resin boot in the present invention, the bellows portion formed such that the convex portions and the concave portions alternately continue in the axial direction includes the plurality of crossed linear grooves, on the surface of the slope that connects the top of the convex portion and the bottom of the concave portion, and therefore, when the surface of the bellows portion is wet with water, it is possible to smoothly discharge the water out of the boot along the linear grooves, regardless of the difference in the discharge direction of the water that is generated due to the difference between the right and left rotation directions of the boot. Further, when the operating angle of the constant-velocity universal joint is large and the facing slopes on the shrink side of the boot bellows portion are strongly pressed onto each other, it is possible to considerably suppress the rubbing noise caused by the stick-slip generated due to the existence of a part of the bellows portion surface that is wet with water and a part that is not wet with water. Furthermore, it is possible to employ a common resin boot for the left side and the right side of the constant velocity joint. As a result, there is a problem that the productivity is poor and the installation workability is complicated. In addition, by setting the size of the linear groove in an appropriate range, it is possible to suppress the generation of the rubbing noise while maintaining the durability of the resin boot.

### BRIEF DESCRIPTION OF DRAWINGS

FIG. 1 is a schematic structure diagram of a constant-velocity universal joint to which a boot for the constant-velocity universal joint in an embodiment is attached.

FIG. 2 is a diagram showing a state where the constant-velocity universal joint in FIG. 1 is rotated at a predetermined operating angle θ1°.

FIG. 3 is a cross-section view of the boot for the constant-velocity universal joint shown in FIG. 1.

FIG. 4 is an enlarged view of a part Y in FIG. 3.

FIG. 5 is a partial enlarged view of a slope of a bellows portion shown in FIG. 4.

FIG. 6 is a cross-section view of the slope shown in FIG. 5.

### DESCRIPTION OF EMBODIMENT

Hereinafter, an example of a boot for a constant-velocity universal joint that is attached to the constant-velocity universal joint provided in a vehicle will be described as an embodiment of a resin boot according to the present invention. First, the constant-velocity universal joint will be described, and subsequently, the boot for the constant-velocity universal joint to which the resin boot in the present invention is applied will be described.

Generally, in the motive power transmission in a vehicle or the like, the motive power is transmitted from an engine to a transmission, a propeller shaft, a differential gear, a driving shaft (constant-velocity universal joint) and wheels, in this order.

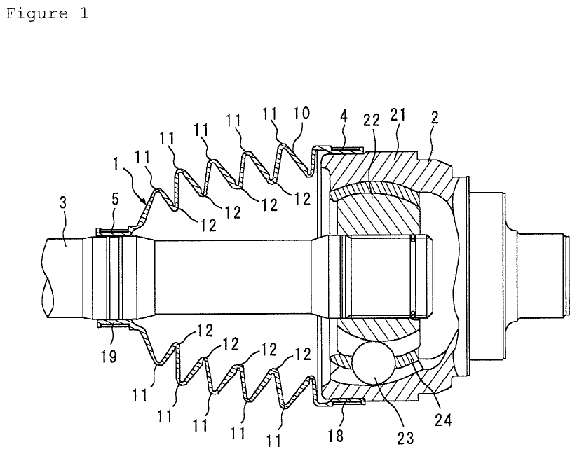

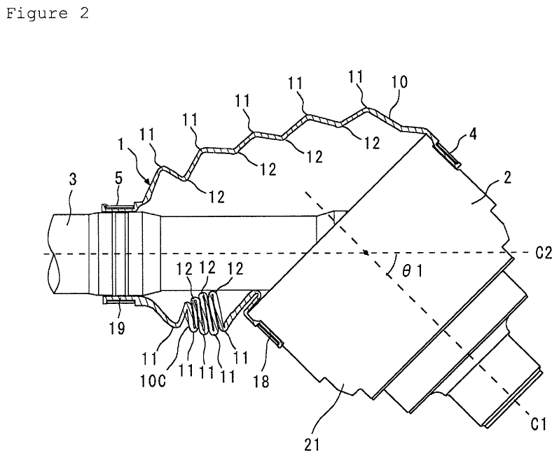

FIG. 1 shows a schematic structure diagram of a constant-velocity universal joint 2 to which a boot 1 for the constant-velocity universal joint according to the embodiment (hereinafter, referred to as a boot 1) is attached, and FIG. 2 shows a state where the constant-velocity universal joint 2 in FIG. 1 is rotated at a predetermined operating angle θ1°. The constant-velocity universal joint 2 as an example shown in FIG. 1 has, as main constructional elements, an outer housing 21, an inner ring 22, a plurality of balls 23 as a torque transmission member, and a cage 24. In the outer housing 21, the inner ring 22 is contained, and between the outer housing 21 and the inner ring 22, the plurality of balls 23 are roll able incorporated at equal intervals by the cage 24. Moreover, at the center in the axial direction of the inner ring 22, an end portion of the driving shaft 3 is saline-fitted, and the inner ring 22 and the driving shaft 3 are rotatably joined. Further, the outer housing 21 is rotatably joined to the gear or a hub provided on the wheel. Thereby, in the constant-velocity universal joint on the in board side, a rotation torque transmitted from the differential gear to the outer housing 21 is transmitted at a constant velocity to the inner ring 22 to which the driving shaft 3 is joined, through the balls 23 as the torque transmission member. In the constant-velocity universal joint on the outboard side, the rotation torque transmitted from the driving shaft 3 to the inner ring 22 is transmitted at a constant velocity to the outer housing 21 to which the hub is joined, through the balls 23. Further, as shown in FIG. 2, by the rolling of the balls 23, the constant-velocity universal joint 2 can change an operating angle θ1 that is the cross angle between an axial line C1 of the outer housing 21 and an axial line C2 of the inner ring 22, from 0° to a predetermined maximum operating angle θ1ₘₐₓ°.

Moreover, between the outer circumference of the above-described outer housing 21 and the outer circumference of the driving shaft 3 joined to the inner ring 22, the boot 1 as the resin boot according to the present invention is provided, for the purpose of the prevention of the intrusion of dust and water and the protection of grease as lubricant filled into the constant-velocity universal joint 2.

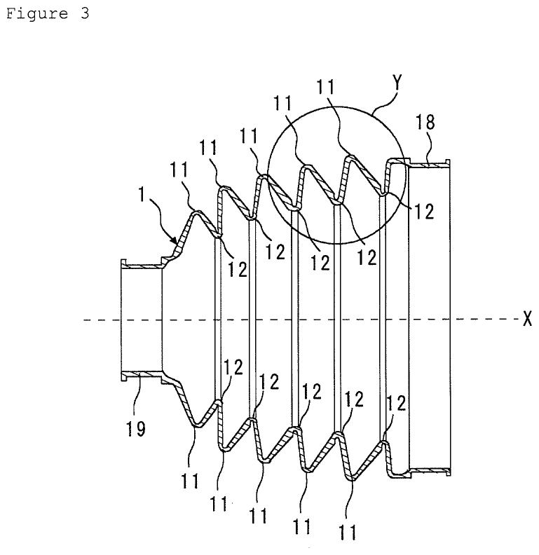

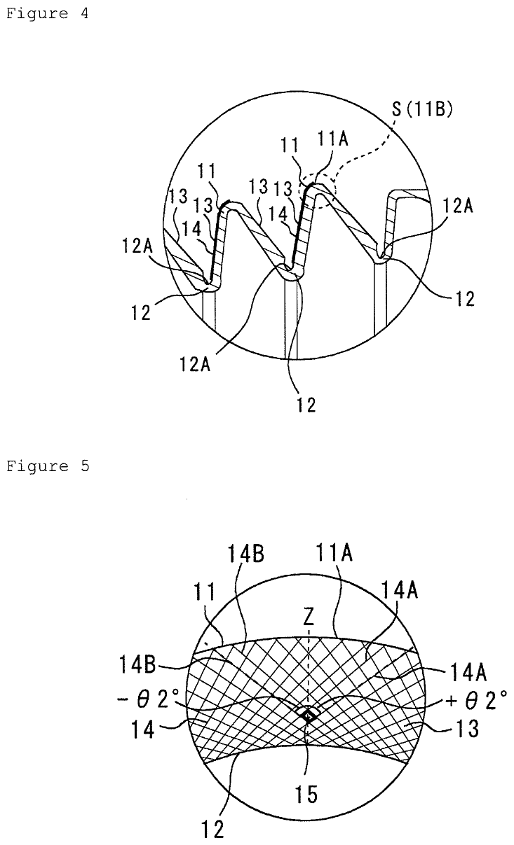

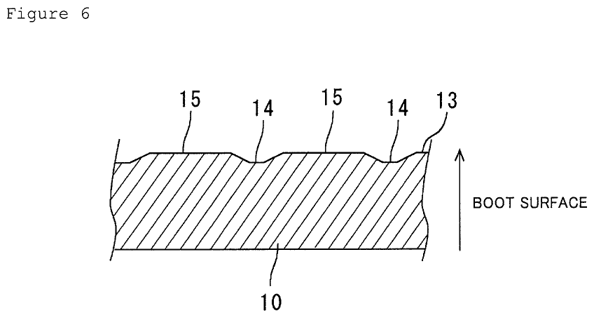

The boot 1 according to the embodiment will be described below in detail, with reference to FIG. 3 to FIG. 6. FIG. 3 is a cross-section view of the boot 1 shown in FIG. 1, FIG. 4 shows an enlarged view of a part Y in FIG. 3, FIG. 5 is a partial enlarged view of a slope 13 of a boot bellows portion 10 shown in FIG. 4, and FIG. 6 is a cross-section view of the boot slope 13 shown in FIG. 5.

The boot 1 according to the embodiment is a resin boot including a cylindrical boot bellows portion 10 formed such that convex portions 11 and concave portions 12 alternately continue in the axial direction, and a large-diameter-side end portion 18 and small-diameter-side end portion 19 continuously provided at both ends of the boot bellows portion 10. The boot bellows portion 10, the large-diameter-side end portion 18 and the small-diameter-side end portion 19 are integrally molded with an elastic material. It is preferable that the boot bellows portion 10, the large-diameter-side end portion 18 and the small-diameter-side end portion 19 be formed of, for example, a thermoplastic elastomer material by blow molding. The material composing the resin boot in the present invention is not particularly limited to the thermoplastic elastomer material, and materials that are conventionally used can be used. Further, the molding method for the resin boot is not limited to the blow molding, and methods that are conventionally used can be employed.

In the embodiment, the outer housing 21 of the above-described constant-velocity universal joint 2 is inserted into the large-diameter-side end portion 18 continuously provided at one end of the boot bellows portion 10, and the driving shaft 3 joined to the inner ring 22 of the above-described constant-velocity universal joint 2 is inserted into the small-diameter-side end portion 19 continuously provided at the other end of the boot bellows portions 10. In a state where the constant-velocity universal joint 2 and the driving shaft 3 are inserted, the large-diameter-side end portion 18 and the small-diameter-side end portion 19 are fastened to the outer housing 21 of the constant-velocity universal joint 2 and the outer circumference surface of the driving shaft 3, by boot bands (fastening members) 4, 5.

The constant velocity universal joint 2 is covered by the boot 1 in a state in which grease as a lubricant is enclosed. Further, the boot 1 extends or contracts while following the change in the operating angle θ1 of the constant-velocity universal joint 2, because of including the boot bellows portion 10 formed of an elastic material. By adopting such a construction, in the constant-velocity universal joint 2, a foreign matter from the exterior is blocked by the boot 1, and a smooth rotation is maintained even when the operating angle θ1 is large.

As shown in FIG. 4, the resin boot according to the present invention includes a plurality of crossed linear grooves 14, on a surface of a boot slope 13 that connects a top 11A of the convex portion 11 and a bottom 12A of the concave portion 12 in the boot bellows portion 10 in which the convex portion 11 and the concave portion 12 are alternately formed. In FIG. 4, the region of the boot slope 13 on which the linear grooves 14 are formed is shown by a thick line.

Note that, as shown in FIG. 5, the plurality of crossed linear grooves 14 formed on the surface of the boot slope 13 are formed at predetermined angles. Specifically, the linear grooves 14 include linear grooves 14A having an angle of +θ2° and linear grooves 14B having an angle of −θ2°. Note that, as shown in FIG. 5, the positive angle (+θ2°) of the linear groove 14A is a clockwise angle with respect to a radial center line Z of the boot 1, and the negative angle (−θ2°) of the linear groove 14B is a counterclockwise angle with respect to the radial center line Z of the boot 1. Further, it is preferable that the plurality of linear grooves 14A, 14B be formed on the surface of the boot slope 13, so as to extend in different directions and be in a netlike form.

Since the plurality of crossed linear grooves 14 are formed on the surface of the boot slope 13 in this way, the water existing on the surface of the boot bellows portion 10 can be discharged out of the boot 1 by the linear grooves 14, regardless of the rotation direction of the boot 1. Furthermore, even when the operating angle θ1 of the constant-velocity universal joint 2 is large and the facing boot slopes 13 on a shrink side 10C of the boot bellows portion 10 are strongly pressed onto each other as shown in FIG. 2, it is possible to suppress the rubbing noise (abnormal sound) due to the stick-slip. In addition, since the resin boot according to the present invention can suppress the generation of the rubbing noise regardless of the rotation direction of the boot 1, it is possible to adapt a common resin boot for the left side and right side of the constant velocity joint, and productivity and mounting workability can be improved.

Further, it is preferable that the angle between the radial center line Z of the boot 1 and the linear groove 14A or 14B be the angle of the direction of the synthetic vector of the centrifugal force to be generated in the boot 1 that occurs with the rotation of the constant-velocity universal joint 2 and the gravitational force of the drop of water droplets on the surface of the boot 1. Specifically, the direction of the synthetic vector to be generated by each of the positive rotation and negative rotation of the constant-velocity universal joint 2 varies depending on the rotation velocity, and therefore, it is preferable that the angle between the radial center line Z of the boot 1 and the linear groove 14 be ±40° or more and ±80° or less (40° to 80° or −40° to −80°), in consideration of the rotation velocity of the constant-velocity universal joint 2. The reason for this is that if the absolute value of the angle between the imaginary line Z and the linear groove 14 is smaller than 40° or larger than 80°, the linear groove 14 prevents smooth water discharge. This is because the angular difference between the angle of water flowing on the surface of the boot and the linear groove 14 is increased by the centrifugal force generated by either normal rotation or reverse rotation of the constant velocity universal joint 2.

Furthermore, it is preferable that the linear groove 14 be formed so as to extend to the top 11A of the convex portion 11 as shown in FIG. 4. This is because, when the linear groove 14 is formed so as to extend to the top 11A of the convex portion 11, the water on the surface of the boot 1 can be smoothly led to the top 11A of the convex portion 11 and the water on the boot surface can be smoothly discharged. Particularly, when the operating angle θ1 of the constant-velocity universal joint 2 is large as shown in FIG. 2, the boot slopes 13 on the shrink side 10c of the boot bellows portion 10 are strongly rubbed with each other, so that the linear groove 14 may be closed and a smooth discharge of the water may be disturbed. However, since the linear groove 14 is formed so as to extend to the top 11A of the convex portion 11, the water can be smoothly guided to the top 11A of the convex portion 11 and can be discharged to the exterior.

In addition, it is preferable that a top portion including the top 11A of the convex portion 11 on which the linear groove 14 is formed has a shape having a predetermined curvature. In FIG. 4, a top portion 11B of the convex portion 11 constructing the boot bellows portion 10 is denoted by S. Since the top portion 11B of the convex portion 11 has a shape having a predetermined curvature as shown in FIG. 4, even when the boot slopes 13 on the shrink side 10C of the boot bellows portion 10 are strongly rubbed with each other, the top portions 11B of the shape do not come into contact with each other, and therefore, the water having reached the top 11A is smoothly discharged.

Further, it is preferable that the depth of each linear groove 14 be 5% to 30% of the thickness of the slope 13 of the boot bellows portion 10 on which the linear groove 14 is formed. This is because, when the depth of the linear groove 14 is less than 5% of the thickness of the boot slope 13, the groove is too shallow, and therefore due to the abrasion of the boot itself, it is difficult to maintain a sufficient drainage effect for a long time. Furthermore, this is because, when the depth of the linear groove 14 is more than 30% of the thickness of the boot slope 13, the groove is too deep, and therefore it is impossible to maintain the strength of the boot slope 13 on which the linear groove 14 is formed, causing the decrease in the strength of the whole of the boot 1 as a result.

In addition, when the boot 1 for the constant-velocity universal joint is formed of a thermoplastic elastomer material not containing an additive agent for giving water-repellent property, it is preferable that the width of each linear groove 14 be 100 μm to 800 μm. This is because, when the width of the linear groove 14 is below 100 μm, water droplets are hard to enter the liner groove 14 and the drainage is difficult. Further, if the width of the linear groove 14 exceeds 800 μm, the number of island area per 1 cm² of the island area 15 surrounded by the linear groove 14 decreases as described later, and the durability of the bellows portion 10 decreases.

Note that, as shown in FIG. 5, the island region 15 is a nearly parallelogram island region that is formed by a total of four linear grooves: two adjacent linear grooves 14A having an angle of +θ2° with respect to the radial center line Z of the boot 1 and two adjacent linear grooves 14B having an angle of −θ2° with respect to the radial center line Z of the boot 1, and is an island region surrounded by thick lines.

It is preferable that the number of the island regions 15 be 16 to 90 island regions/cm², in consideration of the width of linear groove 14. This is because, if the number of island area 15 is less than 16 island regions/cm², the number of island region 15 formed on the slope 13 decreases, which affects the durability of the bellows portion 10.

Further, it is preferable that the cross-section of the linear groove 14 has a trapezoidal shape. Specifically, it is preferable to be a trapezoidal shape that expands as being closer to the surface of the boot as shown in FIG. 6. Note that, a corner portion of the trapezoidal groove cross-section may have the shape having a predetermined curvature. This can form a trapezoid with an accurate cross section when a groove processing method such as laser processing is used. However, in the groove processing method by wet etching or the like, the lower bottom of the groove cross-sectional shape may be rounded and may not be formed into an accurate trapezoidal shape. The width of the linear groove 14 is the length corresponding to the upper base of the trapezoidal shape. When the linear groove 14 has the above-described trapezoidal shape in this way, water droplets on the boot slope 13 partially enters the linear groove 14 easily, and therefore, the water on the boot slope 13 can be smoothly discharged to the exterior.

Further, it is preferable that the corner portion of the cross-section of the linear groove 14 has the shape having a predetermined curvature. By making the cross section of the linear groove 14 corner portion into the shape having a predetermined curvature, it is possible to realize good removability from the mold at the time of blow molding of the constant velocity joint boot 1.

The liner groove 14 only needs to be formed on at least one of the boot slopes 13, and does not need to be provided on both sides of the facing boot slopes 13. By forming the linear grooves 14 in at least one of the boot slopes 13, the opposing slopes 13 of the boot 1 rub against each other when the constant velocity universal joint 2 has a large operating angle θ1. However, even under such circumstances, the water droplets on the slope 13 are well discharged to the outside through the linear grooves 14. In particular, when the linear groove 14 is formed on only one of the boot slopes 13, the contact area of the boot slopes 13 facing each other of the boot 1 can be increased, so the contact pressure can be reduced and the durability can be improved.

Furthermore, the linear groove 14 may be formed on at least a part of the boot slopes 13 facing each other at an operating angle θ1 of 30° or more of the constant velocity universal joint 2. In particular, linear grooves 14 may be formed in each of at least three pairs opposing slopes 13 counted from the large diameter end of the boot 1. This is to maintain the mechanical characteristics of the constant velocity universal joint boot 1 by forming the linear groove 14 only on the minimum necessary slope 13 in order to suppress the rubbing noise caused by the stick-slip phenomenon described above. As a result, the durability can be improved.

### EXAMPLE

An example will be described below. In this example, a resin boot was made using a polyolefin elastomer that was a thermoplastic elastomer. In the example, the linear groove 14 was formed only on one boot slopes 13 of two pairs of facing boot slopes 13 of the first and second boot slopes 13 counting from the large-diameter-side end portion (see FIG. 4). As the angle between the linear groove 14 and the radial center line Z of the boot 1, two kinds: +55° and −55° were adopted. Further, the depth of the linear groove 14 was 0.1 mm, while the thickness of the boot bellows portion 10 was 1 mm. The cross-section of the linear groove 14 had a trapezoidal shape, the width of the bottom of the linear groove 14 was 150 μm, and the width of the top of the groove was 550 μm. The width (the length of one side of the nearly parallelogram shown in FIG. 5) of the island regions 15 surrounded by the linear grooves 14 was 850 μm. In this case, the number of the island regions 15 surrounded by the linear grooves 14 was about 26 island regions/cm².

### Comparative Example

### Comparative Example 1

Comparative Example 1 is different from the above-described Example, only in a point of whether the linear groove 14 is formed. That is, Comparative Example 1 was made using the same material as Example 1, but the linear groove 14 was not formed on the slope 13 of the boot bellows portion 10.

### Comparative Example 2

In Comparative Example 2, using the same material as that of the above-described embodiment, a resin boot in which the slope 13 of the boot bellows portion 10 was subjected to a satin treatment was produced. As for the surface roughness of the slope 13 of the boot bellows portion 10, after the satin treatment, the ten-point average roughness (Rz) was 65 μm to 100 μm.

### <Comparison of Example and Comparative Examples>

In order to confirm the effect of the linear groove 14 in the present invention, the rubbing noise confirmation test was conducted using the resin boots of the above-described Examples and Comparative Examples. The rubbing noise confirmation test was carried out at a predetermined operating angle θ1 while applying water to the resin boot and at a rotational speed of 50 rpm to 200 rpm. This test was performed at operating angles θ1 of 40° and 43°. The result of the rubbing noise confirmation test is shown in Table 1.

TABLE 1

| | | Operating angle | | | |
|---|---|---|---|---|---|
| | | 40° | | 43° | |
| | | Sound Pressure | | Sound Pressure | |
| | | level (dB) | Generation | level (dB) | Generation |
| | | difference with | of rubbing | difference with | of rubbing |
| | Condition | background noise | noise | background noise | noise |
| Example | With linear | 0 | ◯ | 8.1 | Δ |
| | groove | | | | |
| Comparative | No linear | 26.9 | X | 32.1 | X |
| Example 1 | groove | | | | |
| Comparative | Satin | 19.2 | X | 19.2 | X |
| Example 2 | Treatment | | | | |

◯: No rubbing noise
Δ: Rubbing noise occurs after 30 minutes or more
X: Rubbing noise occurs after about 10 minutes

As shown in the example of Table 1, the sound pressure level (dB) of the difference with the background noise (hereinafter, referred to as merely the “sound pressure level”) at the operating angle of 40° was 0 dB, and no the rubbing noise occurred. Further, at the operating angle of 43°, the rubbing noise occurred after 30 minutes or more after the start of the test, but the sound pressure level was as low as 8.1 dB. On the other hand, in Comparative Example 1 in which there is no linear groove, at the operating angle of 40°, the rubbing noise occurred after about 10 minutes after the start of the test, and the sound pressure level was as high as 26.9 dB. Further, in Comparative Example 1, in the case of the operating angle of 43°, the sound pressure level was even higher, and was 32.1 dB. Furthermore, in Comparative Example 2 in which the satin treatment, at the operating angle of 40°, the rubbing noise occurred after about 10 minutes after the start of the test. The sound pressure level at this time was 19.2 dB, and was lower than that in Comparative Example 1, but the rubbing noise could not be suppressed. In Comparative Example 2, in the case of the operating angle of 43°, the rubbing noise occurred after about 10 minutes, and the sound pressure level was 19.2 dB.

From this test result, it is possible to confirm that when the slope 13 of the boot bellows portion 10 includes the linear groove 14 in the present invention, the generation of rubbing noise can be suppressed compared to the case where there is no linear groove or when the surface roughness is increased (satin treatment).

In the above-described embodiment, the boot for the constant-velocity joint that is provided on the constant-velocity joint shown in FIG. 1 has been described as an example. However, the present invention is not limited to this, and can be similarly applied to a boot for a constant-velocity joint that is provided on another constant-velocity joint, for example, a known fixed joint or sliding joint, and a rack boot that is used in a rack-and-pinion steering apparatus.

### INDUSTRIAL APPLICABILITY

Since the water on the surface of the boot bellows portion can be smoothly discharged, the resin boot according to the present invention can provide a resin boot that is used in a state where the boot slopes contact with each other, and is industrially useful.

### REFERENCE SIGNS LIST

C1 Axial line of outer housing
Co. Axial line of inner ring
θ1 Operating angle of constant-velocity universal joint
θ2 Angle between radial center line Z of boot 1 and linear groove
X Axial direction
Z Radial center line of boot 1
1 Boot (resin boot) for constant-velocity universal joint
2 Constant-velocity universal joint
3 Driving shaft
4, 5 Boot band (fastening member)
10 Boot bellows portion
10c Shrink side
11 Convex portion
11A Top
11B Top portion
12 Concave portion
12A Bottom
13 Slope
14, 14A, 14B Linear groove
15 Island region
18 Large-diameter-side end portion
19 Small-diameter-side end portion
21 Outer housing
22 Inner ring
23 Ball
24 Cage

1. A resin boot including a cylindrical bellows portion formed such that convex portions and concave portions alternately continue in an axial direction, wherein
the bellows portion includes a plurality of crossed linear grooves, on a surface of a slope that connects a top of the convex portion and a bottom of the concave portion.

2. The resin boot according to claim 1, wherein the linear grooves extend to the top of the convex portion.

3. The resin boot according to claim 1, wherein the linear grooves are included on at least one of slopes that face each other across the bottom.

4. The resin boot according to claim 1, wherein the linear grooves are formed at an angle of 40° to 80° or −40° to −80° with respect to a radial center line of the resin boot.

5. The resin boot according to claim 1, wherein a depth of the linear grooves are 5% to 30% of a thickness of the slope.

6. The resin boot according to claim 1, wherein a width of the linear grooves are 100 μm to 800 μm.

7. The resin boot according to claim 1, wherein the number of island regions surrounded by the linear grooves are 16 to 90 island regions/cm².

8. The resin boot according to claim 1, wherein a cross-section of the linear grooves have a trapezoidal shape.

9. The resin boot according to claim 1, the resin boot being a boot for a constant-velocity universal joint and including:
a large-diameter-side end portion into which an outer housing of the constant-velocity universal joint is inserted; and
a small-diameter-side end portion into which a shaft member is inserted, the shaft member being joined to the constant-velocity universal joint, wherein
the linear grooves are included on at least one of slopes that face each other across the bottom, at least parts of the slopes coming into contact with each other when an operating angle is 30° or more, the operating angle being a cross angle between an axis line of the outer housing and an axis line of the shaft member.
